(19) United States
(12) Patent Application Publication
(10) Pub. No.: US 2008/0248151 A1
(43) Pub. Date: Oct. 9, 2008

(54) CAVITY INSERT POSITIONING MECHANISM OF AN INJECTION MOLD

(76) Inventors: Chih-Yu CHEN, Tu-Cheng City (TW); Jian-Guang Huang, Tu-Cheng City (TW); Yun-Qing He, Tu-Cheng City (TW); Chun-Yan Wu, Tu-Cheng City (TW); Lin-Chong Zhu, Tu-Cheng City (TW)

Correspondence Address: BIRCH STEWART KOLASCH & BIRCH, PO BOX 747, FALLS CHURCH, VA, 22040-0747, US

(21) Appl. No.: 11/697,279

(22) Filed: Apr. 5, 2007

(51) Int. Cl. B29C 45/00

(52) U.S. Cl. 425/192 R

(57) ABSTRACT

A mold insert positioning mechanism of an injection mold includes a top clamping plate, a cavity insert, a restricting bar, multiple screws and a cavity plate fastened on the top clamping plate. The mold cavity is arranged in an approximate central position of the cavity plate so as to form a locating surface, a second back side and a third wall. The accepting space is arranged on the edge of the cavity plate and communicates with the mold cavity so as to form a first front side, a first connecting side, a second front and a connecting side. The second back side urges the cavity insert to move in on the locating surface so as to position the cavity insert once the cavity insert moves in the mold cavity. Multiple screws lock the restricting bar and the cavity plate as an integral so that the cavity insert is positioned in the mold cavity completely.

### BACKGROUND OF THE INVENTION

1. Field of the Invention

This present invention generally relates to an injection mold, and more particularly to a cavity insert positioning mechanism. The cavity insert positioning mechanism helps to position the cavity insert in a determined position.

2. Related Art

A conventional cavity insert positioning mechanism includes a cavity plate, a cavity insert, plurality of wedges and plurality of screws. A mold cavity for accepting the cavity insert is defined in an approximate central portion of the cavity plate. Plurality of wedge-receiving cavities are formed by the side of the mold cavity for receiving the corresponding wedges therein. Each wedge further has a screw hole penetrating itself surface. In assembly, the cavity insert is installed in the mold cavity, and the wedges are respectively placed in the corresponding wedge-receiving cavities and fastened in the wedge-receiving cavities with screws mentioned above. Therefore, the cavity insert is positioned in a determined position of the cavity plate by the wedges.

However, the above design may take much time to position the cavity insert in a determined position in an assembly process, and further prolong the man-hour and increase the production cost. Hence, a new way to reduce the time of positioning the cavity insert in the assembly process is needed.

### SUMMARY OF THE INVENTION

Accordingly, an object of the present invention is to provide a cavity insert positioning mechanism of an injection mold. The cavity insert positioning mechanism of an injection mold includes a top clamping plate, a cavity plate, a cavity insert, a restricting bar and multiple screws. The cavity plate fastened on the top clamping plate includes a first wall, a second wall and a third wall. The third wall connects to the end portion of the first wall and the second wall. The interior of the first wall has a first front side, a first connecting side and a locating surface. The interior of the second wall has a second front side, a second connecting side and a second back side inclining to the locating surface. The third wall, the locating surface and the second back side surround a mold cavity. The first front side, the first connecting side, the second front side and the second connecting side surround an accepting space which communicates with the mold cavity. The second back side urges the cavity insert to move in on the locating surface so as to position the cavity insert as soon as the cavity insert moves in the mold cavity. Multiple lock screws penetrate the restricting bar to lock the restricting bar and the cavity plate as an integral. Multiple upright screws lock the restricting bar on the top clamping plate. In a word, it is a new way to reduce the time of positioning the cavity insert in assembly process of the mold.

### BRIEF DESCRIPTION OF THE DRAWINGS

FIG. 1 is an exploded view of a cavity insert positioning mechanism according to the present invention;

FIG. 2 is a perspective view that a cavity plate is fastened on the top clamping plate;

FIG. 3 is a perspective view of a restricting bar;

FIG. 4 is a perspective view of the restricting bar from another viewpoint;

FIG. 5 is a perspective view of the cavity insert;

FIG. 6 is a perspective view that the cavity insert moves in on the locating surface; and

FIG. 7 is a perspective view that the cavity insert is positioned in the mold cavity.

### DETAILED DESCRIPTION OF THE PREFERRED EMBODIMENT

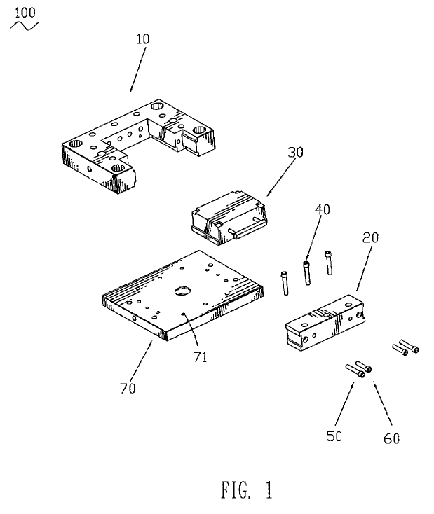

Referring to FIG. 1, a cavity insert positioning mechanism of an injection mold 100 includes a cavity plate 10, a restricting bar 20, a cavity insert 30, a top clamping plate 70 having a plurality of fixing holes 71 formed therein and a plurality of screws having multiple upright screws 40, multiple lock screws 50, multiple handle screws 60.

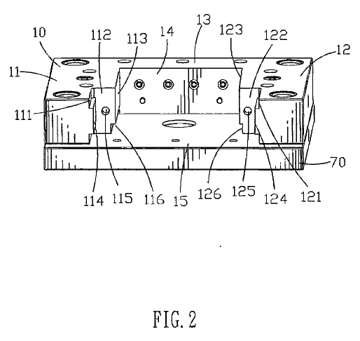

Referring to FIG. 2, the cavity plate 10 is fastened on the top clamping plate 70 and includes a first wall 11, a second wall 12 and a third wall 13. The third wall 13 connects to the end portion of the first wall 11 and the second wall 12. The top clamping plate 70, the first wall 11, the second wall 12 and the third wall 13 define a mold cavity 14 and an accepting space 15. The mold cavity 14 is arranged in an approximate central position of the cavity plate 10. The accepting space 15 is arranged on the edge of the cavity plate 10 and communicates with the mold cavity 14; the accepting space 15 is wider than the mold cavity 14. The interior surface of the first wall 11 includes a first front side 111, a first connecting side 112 and a locating surface 113. The central portion of the vertical direction of the first front side 111 extends toward the interior of the cavity plate 10 to form a first rib 114. The back portion of the first front side 111 extends transversely to form the first connecting side 112, where a first hole 115 is formed thereon. The right of the first connecting side 112 extends lengthwise to form the locating surface 113 whose bottom is formed a first guide notch 116. The second wall 12 corresponds to the first wall 11 and includes a second front side 121, a second connecting side 122 and a second back side 123. The central portion of the vertical direction of the second front side 121 extends toward interior of the cavity plate 10 to form a second rib 124 corresponding to the first rib 114. The end portion of the second front side 121 extends transversely to form the second connecting side 122, where a second hole 125 is formed thereon. The second back side 123 connects to the left portion of the second connecting side 122 and inclines to the locating surface 113. A second guide notch 126 is formed at the bottom of the second back side 123. The third wall 13, the locating surface 113, the first guide notch 116, the second back side 123 and the second guide notch 126 surround the mold cavity 14. The first front side 111, the first connecting side 112, the second front side 121 and the second connecting side 122 surround the accepting space 15.

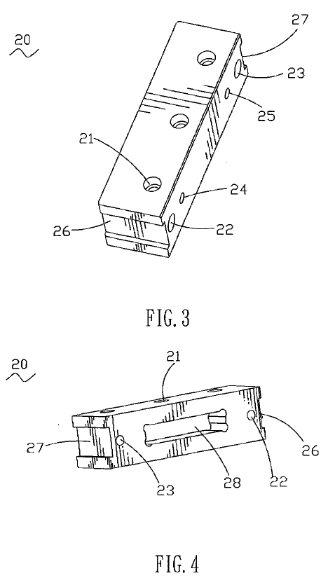

Referring to FIG. 3 and FIG. 4, multiple upright screw holes 21 perforate the restricting bar 20 through the upright direction. A pair of penetrating holes (22, 23) penetrate into the surface of the restricting bar 20. The direction of the penetrating holes (22, 23) is perpendicular to the direction of the multiple upright screw holes 21. A pair of receiving holes (24, 25) used to take in multiple handle screws 60 is respectively defined near the penetrating hole (22, 23). Each end of the restricting bar 20 is respectively defined notches (26, 27). A handle notch 28 is formed at the back surface of the restricting bar 20.

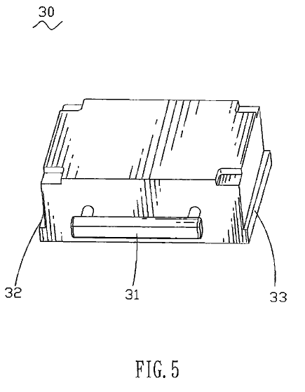

Referring to FIG. 5, a cavity insert 30 which is inserted into the mold cavity 14 has a handle 31 defined at its front surface. A left guide rib 32 and a right guide rib 33 are defined at two opposed ends of the bottom of the cavity insert 30.

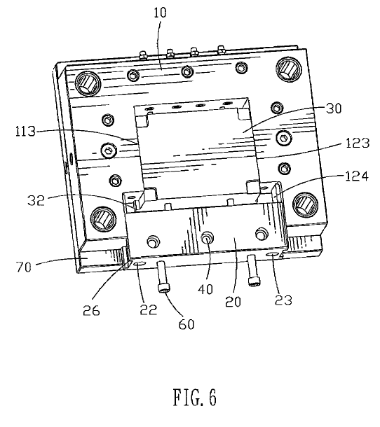

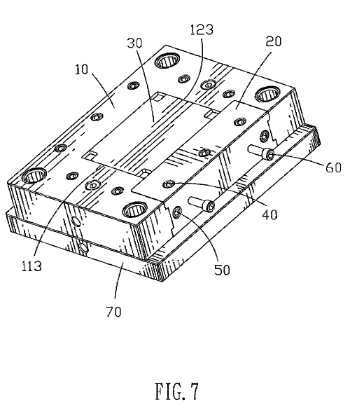

Referring to FIGS. 6-7 and FIGS. 1-2, when the cavity insert positioning mechanism of an injection mold 100 is in use, the first and the second guide rib (32, 33) respectively slide along the first and the second guide notch (116 126) so that a part of the cavity insert 20 is inserted into the mold cavity 14, at the same time, the second back side 123 urges the cavity insert 20 to move in on the locating surface 113, and further, the cavity insert 30 is pushed into the mold cavity 14 once the restricting bar 20 moves in the accepting space 15 along the first and the second rib (14, 124) and forces the cavity insert 30 to move in the mold cavity 14, accordingly, the second back side 123 urges the cavity insert 30 to move in on the locating side 113. In a word, the second back side 123 urges the cavity insert 30 to move in on the locating side 113 so as to position the cavity insert 30 as soon as the cavity insert 30 moves in the mold cavity 14. After the cavity insert 30 is completely entered into the mold cavity 14, the multiple upright screws 40 pass the multiple upright screw holes 21 to lock the restricting bar 20 on the top clamping plate 70, and the multiple lock screws 50 pass the penetrating holes (22, 23) to arrive at the first and the second hole (115, 125) so as to lock the restricting bar 20 and the cavity plate 10 as an integral. In such a way, the cavity insert 30 is positioned in the mold cavity 14 completely. If the cavity insert 30 is taken out from the mold cavity 14, the user may dismantle the multiple upright screws 40 and multiple lock screws 60, then the cavity insert 30 is taken out from the mold cavity 14 through pushing the handle 31 after the restricting bar 20 is taken out from the accepting space 15 by pushing handle screws 60.

What is claimed is:

1. A cavity insert positioning mechanism of an injection mold comprising:
a top clamping plate;
a cavity plate fastened on the top clamping plate and having a first wall, a second wall and a third wall, the interior of the first wall having a first front side, a first connecting side and a locating surface, the interior of the second wall having a right front side, a right connecting side and a right back side which inclines to the locating surface, and the mold cavity surrounded by the first back side, the third wall and the second back side, and the accepting space surrounded by the first front side, the first connecting side, the second front side and the second connecting side;
a cavity insert received in the mold cavity;
a restricting bar for pulling the cavity insert; and
multiple screws used to lock the restricting bar and the cavity plate as an integral and fasten the restricting bar on the top clamping plate;
wherein the second back side urges the cavity insert to move in on the locating surface so as to position the cavity insert as soon as the cavity insert moves in the mold cavity.

2. The cavity insert positioning mechanism of an injection mold as claimed in claim 1, further comprising a first rib arranged in the first front side of the first wall and a second rib arranged in the second front side of the second wall, and a pair of notches formed at two ends of the restricting bar to correspond to the first rib and the second rib.

3. The cavity insert positioning mechanism of an injection mold as claimed in claim 1, further comprising a first guide notch arranged at the bottom of the locating surface and a second guide notch arranged at the bottom of the second back side, a first guide rib arranged on the left of the bottom of the cavity insert to correspond to the first guide notch, and a second guide rib arranged on the right of the bottom of the cavity insert to correspond to the second guide notch.

4. The cavity insert positioning mechanism of an injection mold as claimed in claim 1, further comprising a handle notch formed at the back surface of the restricting bar, and a handle defined in front of the cavity insert to correspond to the handle notch.

5. The cavity insert positioning mechanism of an injection mold as claimed in claim 1, wherein the screws includes multiple upright screws, lock screws and handle screws.
